(19) United States
(12) Patent Application Publication
(10) Pub. No.: US 2023/0072110 A1
(43) Pub. Date: Mar. 9, 2023

(54) Modulated Wave Time of Flight (mwToF) Sensor

(71) Applicant: PreAct Technologies, Inc., Herndon, VA (US)

(72) Inventor: David CLASS, Herndon, VA (US)

(21) Appl. No.: 17/940,279

(22) Filed: Sep. 8, 2022

Related U.S. Application Data
(60) Provisional application No. 63/241,732, filed on Sep. 8, 2021.

(51) Int. Cl. G01S 7/493; G01S 17/89; G01S 17/36; G01S 7/4915

(52) U.S. Cl. CPC G01S 7/493; G01S 17/89; G01S 17/36; G01S 7/4915

(57) ABSTRACT

A modulated wave time of flight (mwToF) sensor combines modern digital signal processing techniques with CW quadrature sampling methods to produce a sensor that is better at rejecting environmental noise such as ambient light as well as electronic noise that comes from sources such as signal amplification.

### CROSS-REFERENCE TO RELATED APPLICATIONS

This application claims priority from U.S. patent application No. 63/241,732 filed Sep. 8, 2021, incorporated herein by reference.

This application is related to copending commonly-assigned U.S. patent application Ser. No. 16/883,679 filed May 26, 2020, incorporated herein by reference.

### FIELD

The technology herein relates to Light Detection and Ranging (LIDAR), and more particularly to time of flight (ToF) optical sensors that measure distance to objects.

### BACKGROUND & SUMMARY

### Lidar Concepts and Typical Lidar Approaches

A LIDAR (Light Detection and Ranging) or ToF (time of flight) sensor is a 3D scanning technique used to measure distance to an object. LIDAR works by illuminating an object with a narrow column of light, and then measuring the reflection in a particular way. The light scattered by the object is detected by a photodetector, which can be a single pixel or a pixel array. By measuring the time of flight for the light to travel to the object and back, distance can be calculated.

Typically, LIDARs are characterized as either pulsed or continuous wave (CW).

Pulsed LIDAR is a somewhat brute force approach to distance measurement. The illumination consists of a single, high-amplitude, short pulse of light. After emitting a pulse, the detector circuit is monitored for reception of the reflected pulse. This technique has the advantage of being relatively simple. However, because the detector is looking for a short pulse of light, performance can degrade significantly in the presence of other LIDARs or in noisy environments. In addition, as the reflectivity and distance of the object varies, pulse amplitudes can vary wildly. Due to finite pulse rise times, this can create errors in the time of flight measurement, known as walk error. Such errors can be reduced but not eliminated via a variety of techniques, such as specialized signal conditioning circuitry or by measuring and compensating for the return pulse amplitude.

Continuous wave (CW) ToF sensors use an indirect distance measurement approach. Instead of transmitting a single pulse of light, CW LIDAR transmits a continuous train of optical pulses as shown in prior art FIG. 1. The emitted waveform can take many shapes, to include sinusoidal or square waves. This emitted signal is reflected by an object and is returned. The returned signal is detected, and compared to the emitted signal. By measuring the phase difference between emitted and returned versions of the same signal, distances can be calculated.

Some past approaches have “chirped” the continuous wave optical carrier to reduce laser power or for other reasons. See e.g., Pollastrone et al, “Fully digital intensity modulated LIDAR”, Defence Technology Volume 12, Pages 290-296 Issue 4, (August 2016); Frequency-Modulated Continuous Wave (FMCW) LiDAR, https://www.bridgerphotonics.com/blog/frequency-modulated-continuous-wave-fmcw-lidar; see also Lagaye et al, Improvement of LIDAR system by modulation of an optical pulse laser for underwater detection, Proceedings Volume 3100, Sensors, Sensor Systems, and Sensor Data Processing; (1997) https://doi.org/10.1117/12.287766.

Quadrature sampling is typically used to perform signal analysis on a returned optical signal. This approach has better mutual interference and noise performance as compared to the pulsed approach because the detection space can be narrowed to a single frequency and observed over many pulses. However, the repeating (e.g., periodic) nature of the signal waveform creates distance ambiguities in measurements that are dependent on frequency. Under high ambient noise conditions, measurements also begin to show some contrast decay, limiting sensitivity and accuracy. For example, under daylight conditions, sunlight can add significant noise and raise the noise floor accordingly—degrading the quality of the measurements.

Approaches in the past to avoid such degradation due to ambient light included hardware solutions such as using multiple capacitors at the detectors to reduce the effects of sunlight. However, such approaches typically were not very effective.

### BRIEF DESCRIPTION OF THE DRAWINGS

FIG. 1: prior art cwToF block diagram

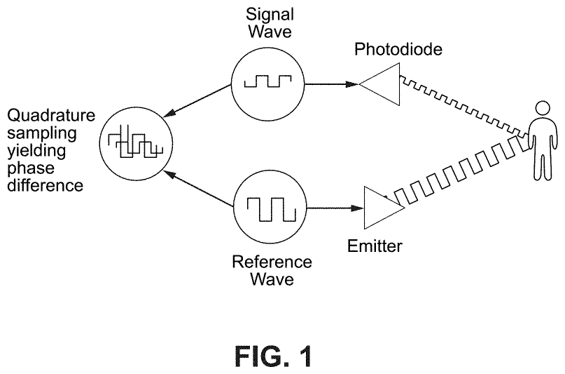

FIG. 2: mwToF block diagram

FIG. 3. Standard mixer circuit for modulating and demodulating input signals

FIG. 4. Analytically computed signals from real world collected data of an 80 MHz carrier 8 MHz modulated signal

FIG. 5. Simulation signal chain

FIG. 6. Simulation signals chain results with +6 dBr of noise injection

FIG. 7. Closeup view of noise injection—noise is +6 dB larger than output signal, and overall amplitude of >4 vs an amplitude of 2 for the output signal

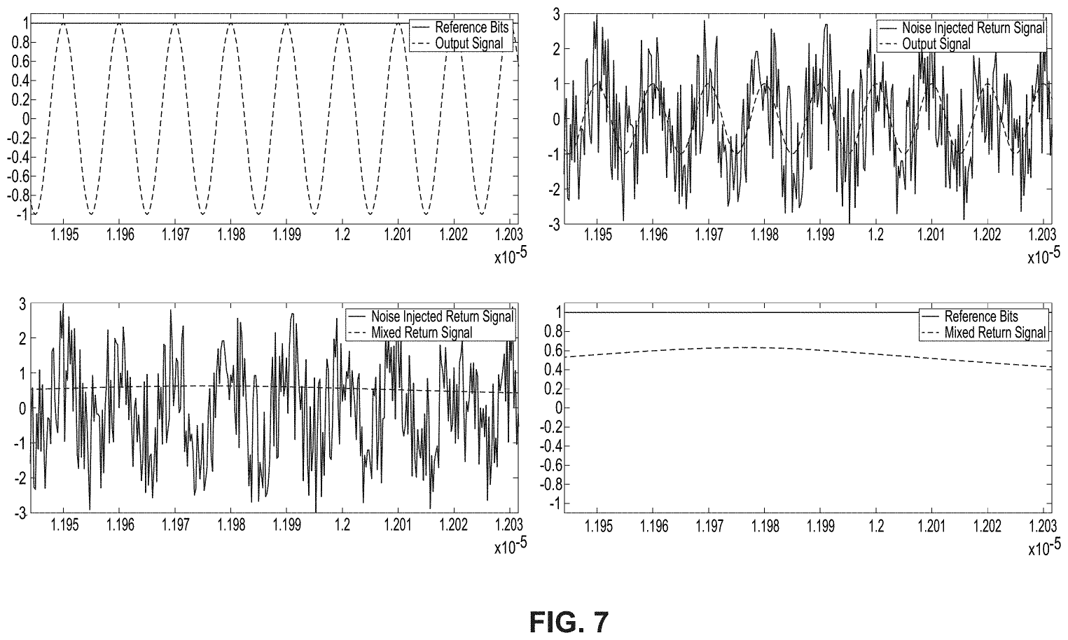

FIG. 8. Power Spectral Density of simulated signals for +6 dBr of noise injection

FIG. 9. Power Spectral density of simulated signals for +10 dBr of noise injection

FIG. 10. Signal chain with +10 dBr of noise injection

### DETAILED DESCRIPTION OF NON-LIMITING EMBODIMENTS

A new type of sensor is uniquely designed to improve the performance of continuous wave time of flight (cwToF) sensors for LIDAR and other applications. The modulated wave time of flight (mwToF) sensor combines modern digital signal processing techniques with CW quadrature sampling methods to produce a sensor that is better at rejecting environmental noise such as ambient light as well as electronic noise that comes from sources such as signal amplification.

The mwToF is a flexible, small, sensor unit that uses modulated light to measure distance. The architecture of the sensor allows for many use cases. Use cases include the classic single emitter—single detector topology, single or multiple emitters with reflections impinging on a focal plane array (FPA) that may be co-located with the emitter(s), or more exotic configurations such as a multi-input, multi-output (MIMO) system.

The general approach is to modulate a typical continuous wave with a carrier wave prior to illumination, and then demodulate the signal before sampling the returned continuous wave to determine the phase shift of the continuous wave and therefore the range of the reflected object. In this context, “modulate” means altering the amplitude and/or frequency and/or phase of an electromagnetic wave or other oscillation in accordance with the variations of a second signal. For general background on socalled “superheterodyne” modulation and demodulation schemes, see e.g., U.S. Pat. Nos. 1,342,885; 1,734,038; and USP 706,740; Roder, “Amplitude, Phase, and Frequency Modulation”, Proceedings of the Institute of Radio Engineers (Volume: 19, Issue: 12, December 1931); Faruque, Radio Frequency Modulation Made Easy (Springer 1st Ed. 2017); Liu, “Optical Modulation”, Chapter 10, pp 297-361. Principles of Photonics, Cambridge University Press (2016) https://www.cambridge.org/core/books/principles-of-photonics/optical-modulation/9BF9A9E46AD8106EF7E86D37A9E3FF51, all incorporated by reference.

In one embodiment, the light signal of interest to the LIDAR distance detection is used to modulate a higher frequency (e.g., 10× in frequency) carrier signal. The modulated carrier signal is sent to illuminate the object. The object returns a delayed version of the modulated carrier signal to the detector. The detector demodulates the returned signal to recover the (delayed) light signal of interest, and then compares the demodulated delayed signal of interest to the original light signal of interest that was used to modulate the carrier signal.

Advantages of such a modulation approach include that the carrier signal can be placed at a frequency that is not substantially interfered with by ambient light and other noise, and highly selective bandpass filters (centered at the carrier frequency as opposed to the frequency of the signal of interest) can be used to filter out spectral noise from the returned signal before it is demodulated.

mwToF System Architecture

A typical cwToF will output a continuous “signal” wave at a set amplitude and (optical) frequency, normally generated by an LED array or sometimes a laser. The wave will strike some object and be reflected back to the sensor's receiving optics that normally illuminate a single or focal plane array of photodiodes. Each pixel is equipped with electronics allowing it to sample the return signal at a precise time and store it, normally in a capacitor associated with the pixel. A quadrature sampling method is most common, with the signal sampled at its minimum and maximum peaks and two zero crossings. A simple equation set is then used to measure phase difference between ingoing and outgoing waves, which directly yields the range from the sensor to the reflected object.

There are two primary challenges with this approach:

The light from the reflected signal wave mixes directly with ambient light, and in prior approaches there is no attempt made to remove ambient light from the signal before sampling.

Building up a total signal from sampling many weak signals is prone to noise as each sample has a relatively low signal-to-noise ratio.

The example non-limiting embodiment introduces an additional signal called a “carrier wave.” The carrier wave can be a sinusoidal wave (although other waveforms are possible) and is selected to have a frequency of 10× or more relative to the frequency of the signal of interest. In the example embodiment, a conventional hererodyne or mixing process is used to modulate the signal of interest onto the carrier wave.

The resulting modulated signal provides side information on either side (up-frequency and down-frequency) centered around the carrier wave, which are the so-called sum and difference frequencies that result from some forms of modulation. The example non-limiting embodiment bandpass filters are designed to pass these sum and difference frequencies but have a restricted bandwidth that passes only a small part of the frequency spectrum that contains the returned signal, centered around the carrier frequency (which can be relatively high). The receiver/detector can thus filter out portions of the spectrum that contain most of the ambient light—which has little frequency content because its not changing very fast. Accordingly, the carrier frequency (and thus the bandpass filter frequencies used on the detecting side) can be varying much faster than any variations of the ambient light, so that such ambient light variations will fall well outside the filter bandpass and will not affect the post-filtered demodulated outputs.

The carrier wave frequency can be appropriately selected to reduce both noise sources, namely ambient light and electronics noise. Ambient light tends to have little frequency content over short time intervals, acting primarily as a DC source. As the return wave can be filtered to focus on a relatively narrow bandwidth around the carrier wave frequency before demodulation, most of the ambient light is removed. Similarly, electronic noise tends to be random or at known frequencies as determined by the electronics design. Assuming the designer chooses noise sources with frequencies sufficiently far from the carrier wave (or chooses the carrier wave to be sufficiently far from the noise sources), much electronic noise can be stripped away in the same manner.

After filtering, the return wave is demodulated to recover the signal of interest and the continuous wave is measured as per normal. Because this signal has reduced noise content, the detector is able to amplify it more aggressively and sample it at higher rates and thus derive higher precision time of flight measurements.

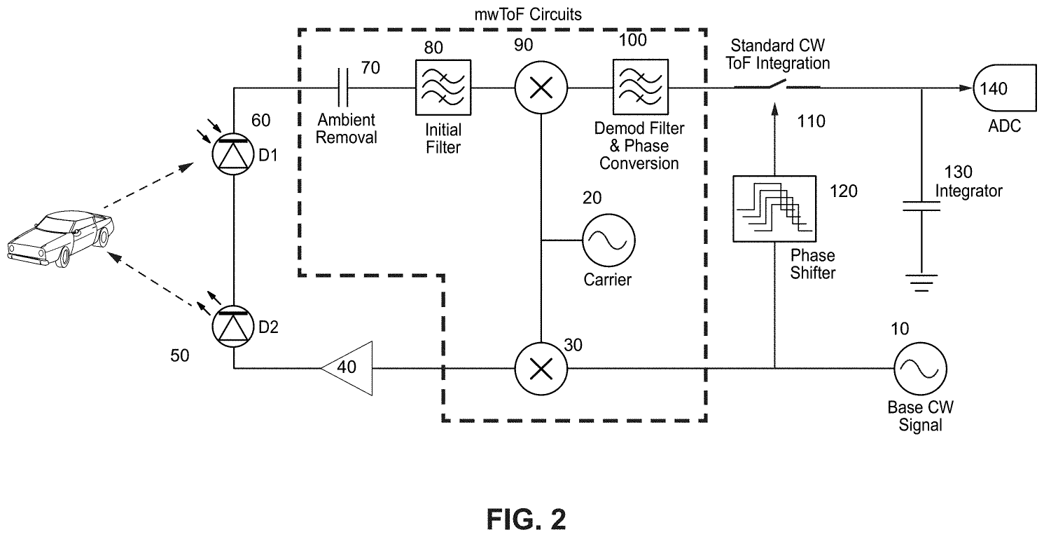

An example process is depicted in FIG. 2. Starting at the bottom of the figure, wave generators 10, 20 develop both a reference wave and a carrier wave. The reference wave (“base CW signal” generated by oscillator 10) will be used as the transmitted signal that is compared with the returned signal. The carrier wave is generated by a local oscillator 20. These two signals are combined (modulated) by mixer 30 into a modified wave that is amplified by amplifier 40 emitted using a pulsed light source 50 such as a VCSEL or LED array. The reflected wave is then received via a photodiode array (one pixel 60 is shown for purposes of simplification, but the array can comprise thousands of such pixels) and the signal is filtered (70, 80), stripping out a portion of ambient light and electronic noise. The filtered signal is demodulated by another mixer 90 connected to local oscillator 20 to recover the returned continuous wave signal. The remaining signal wave is further filtered (100) then compared with the reference wave and sampled using a quadrature scheme or other sampling method (110) to determine the phase shift. For example, a programmable phase shifter 120 may be used to adjustably shift the phase of the reference wave from oscillator 10 by a certain amount to provide a baseline. A capacitive integrator (capacitor) 130 may be used to acquire a charge based on the phase difference, and an analog-to-digital converter 140 may be used to input the integrated phase difference value to a digital processor. The circuitry shown can be duplicated for each pixel in the array to provide many parallel outputs indicating a 3D point cloud.

Unlike a common communication system, the reference signal produced by oscillator 10 does not contain any message that is to be conveyed or transmitted to another location. Rather, this reference signal can have a fixed continuous frequency (e.g., essentially a constant tone) that conveys no message (in this context, “message” is a broad term that can mean voice, music, text, characters, codes such as morse code, or the like), but it need not be fixed or constant—although it should be predictable. The demodulated return of this reference signal reflected by an object is processed by detector 60 (which in this embodiment is co-located with emitter 50) and compared to the original reference signal to determine a phase shift and thus time of flight—which is correlated to distance. Furthermore, a common communications system often modulates a carrier wave with a signal in order to transport the signal via a medium (e.g., a radio antenna, an optical fiber, etc.) that the signal cannot itself travel over. Think for example of an AM radio transmitter that can transport a voice signal thousands of miles. In this implementation, in contrast, the base CW signal could be sent directly to the object via emitter LED or laser 50 but is used to modulate a carrier signal in order to reduce the signal's susceptibility to noise (e.g., ambient light).

Example Instantiation of mwToF—Focus on Demodulation

For both pulsed LIDAR and cwToF approaches, it is useful to consider how the system will be extended beyond a single pixel. For LIDAR, this is done by physically scanning a single emitter/detector pair over a field of view or by using an array of multiple emitters and/or detectors. Scanning makes use of mechanically rotating mirrors, MEMs actuators, or other laser steering technologies, and tends to be too slow to track fast moving objects. cwToF lends itself better to use with a single emitter and an array of detectors. This is due to the ability to easily integrate RF mixing technology onto a typical CMOS or CCD imager chip and integrate returns over time. Because of this, detector arrays for cwToF tend to scale better in cost, size, and power than their pulsed lidar counterparts. However, sample rates are still limited by array readout times and integration times. They are also very challenged in high ambient light conditions such as direct sunlight, and the requirement to build up a signal over many amplified samples tends to amplify signal noise.

The novel mwToF process and system of FIG. 2 incorporates careful demodulation which with bandpass filtering strips out most of the ambient light effects and electrical circuit noise. The signal is received by a focal plane array (FPA)—an array of optical detectors (e.g., 320×240 pixels or more) placed in the focal plane of an imaging system. Thus, unlike a point-to-point or even point-to-multipoint communications system, the present approach emanates a light signal which is then reflected by an object and received by an array of light detectors located on the same focal plane of an optical system such as a lens.

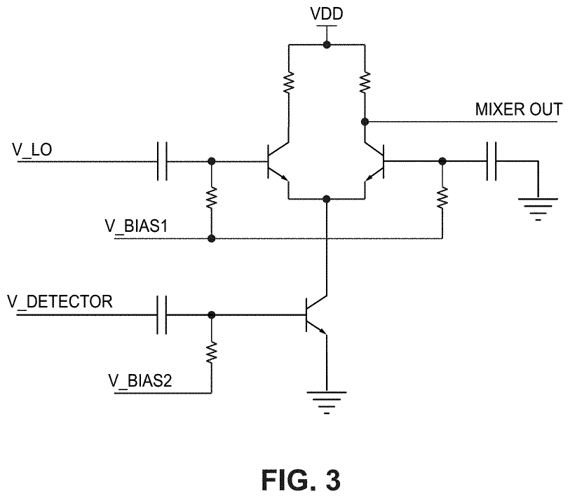

Since demodulation is accomplished per pixel, normally within such a focal plane array (FPA), it is advantageous for the process to be achieved via analog circuitry. In other words, analog circuitry may conveniently be used to concurrently sample, filter and demodulate each of the FPA pixel outputs. That said, as digital sampling methods become faster and more robust, one would certainly expect that these may also be used for mwToF. In particular, the sampling frequency determines the maximum range, and as of this writing the sampling frequency would be a minimum of 6 MHz to achieve desired range measurements for a 3D point cloud. Even a modestly sized FPA will require a massive number of samples, which make analog circuitry a preferred (but not an exclusive) choice as of this writing. Conventional PN-junction, PNP-transistor-based or field effect transistor (FET) based analog demodulator circuits suitable for such applications (see FIG. 3 for one example mixer circuit using a pair of NPN transistors in a common emitter connection to a further NPN transistor) are well known and can be structured to be compact and draw little power. Such a cluster of analog demodulators implemented for example in a custom ASIC can be connected to a high density FPA to provide a bundle of thousands or tens of thousands of demodulated outputs simultaneously each of which can be used to determine a range of a respective spatial area defined by a receiving optical system.

There are many different forms of modulation, all of which can be applied to mwToF. Common modulation schemes include amplitude shift keying (ASK), frequency shift keying (FSK) and phase shift keying (PSK). Any number of different demodulation schemes have been developed for each. FIG. 2 is consistent with an example of PSK, where the reference square wave is modulated in phase by the sinusoidal carrier wave. Note how the carrier wave phase shifts per reference wave edge transition. A PSK wave may readily be demodulated with analog circuitry such as shown in FIG. 3.

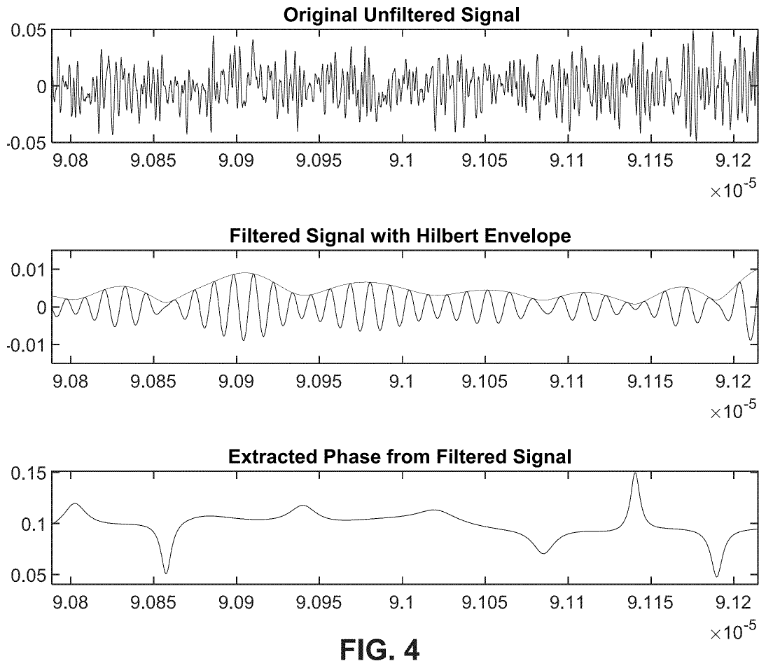

A difficult portion of the architecture is producing the analog phase measurement of the demodulated signal. It is clearly viewed in the analytically filtered extracted signal of real-world measurements. This extracted phase signal is then converted to an absolute amplitude that is fed into the standard CW modulation elements, as FIG. 4 shows.

mwToF Simulation Results

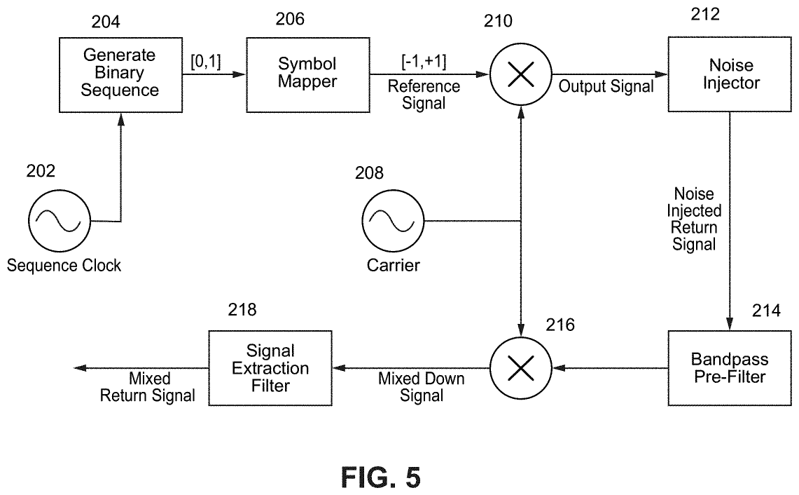

Simulation was performed utilizing this mwToF theory examining its ability to remove injected noise. For the simulation, the sequence clock rate of 10 MHz and carrier clock rate of 100 MHz were chosen. As shown in FIG. 5, there were seven steps implemented in the simulation signal chain.

A randomized bit pattern is generated (202, 204), note that for mwToF the “randomized bit pattern” would simply be the standard cwToF signal (“10” repeating).

Reference signal: The symbol mapper (206) converts a 0 to a −1 to balance the output signal, in all the figures to follow this is called the reference signal.

Output signal: The mixer (210) then receives the reference signal and a carrier signal generated by a 100 MHz local oscillator (208) and mixes the frequency content up to be centered about 100 MHz.

Noise injected return signal: The noise injector block (212) inserts randomized noise of user selected amplitude.

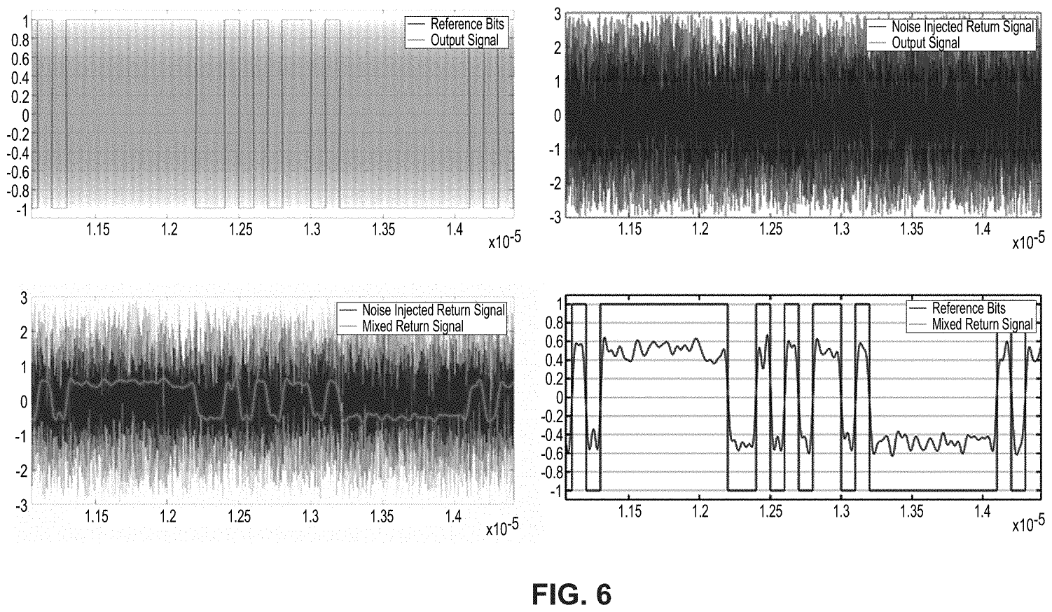

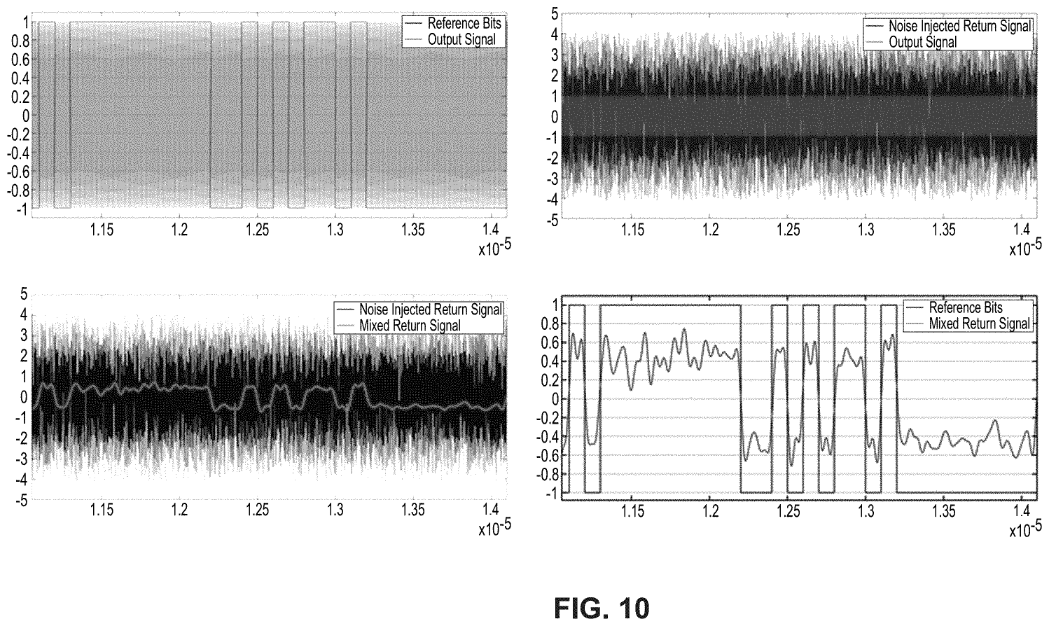

FIG. 6 shows this process with +6 dBr of noise and FIG. 10 with +10 dBr of noise.

Note, dBr is dB using the output signal as its reference level. So +6 dBr of noise means that the amplitude of the noise is twice as large as the amplitude of the output signal.

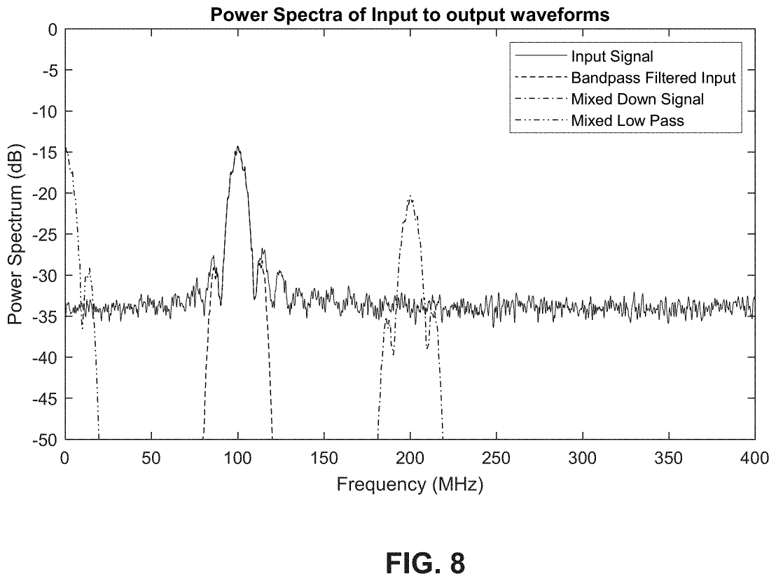

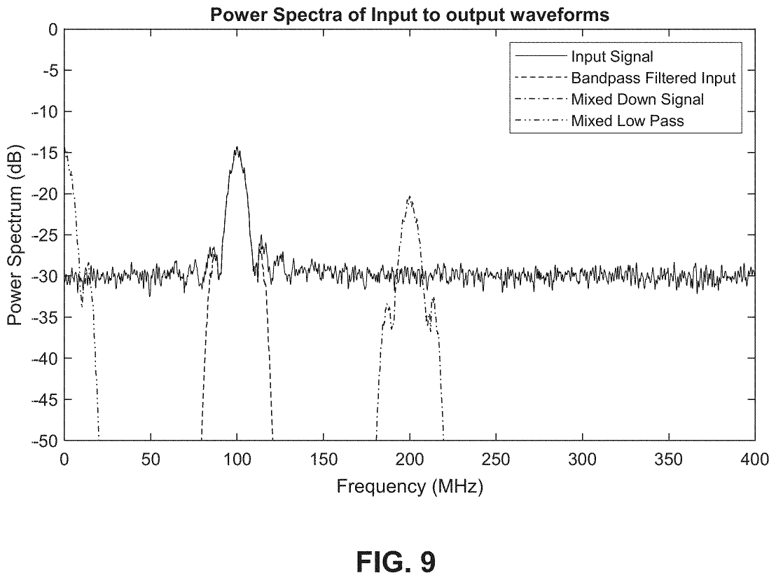

As shown in FIG. 8 and FIG. 9, the spectral density of the randomized noise is flat.

A bandpass pre-filter 214 centered around the 100 MHz carrier frequency filters out portions of the frequency spectrum above and below the carrier frequency, including ambient light. The bandpass pre-filter is applied to the received signal to remove any aliasing and spurious affects

A second mixer 216 receives the carrier signal from the local oscillator and mixes the filtered returned signal down to baseband. At this point in the signal chain the signal contains both DC signal and a signal at twice the carrier superimposed (200 MHz).

A signal extraction filter 218 extracts the baseband signal for use in a conventional phase comparison. Mixed Return Signal: A signal extraction filter is then applied to remove the high frequency 200 MHz signal leaving just the original Reference Signal. This can then be used as an input directly into the standard cwToF range measurement or other phase extraction schemes.

All patents and publications cited herein are incorporated by reference.

1. A LIDAR system comprising:
a signal reference,
a light emitter that emits light,
an array of light detectors that each receive emitted light reflected from an object(s), and
filter and demodulation circuitry coupled to each of the light detectors, the filter and demodulation circuitry structured to demodulate the received emitted light for comparison to the signal reference to derive phase differences related to distance of the object(s).

2. The LIDAR system of claim 1 wherein the light emitter and array of light detectors are co-located.

3. The LIDAR system of claim 1 wherein the system is not structured to transport a message from the light emitter to the array of light detectors.

4. The LIDAR system of claim 1 further including range determining circuitry that determines ranges from the phase differences to provide a 3D point cloud.

5. The LIDAR system of claim 1 wherein the filter and demodulation circuitry filters out phase effects due to ambient light.

6. The LIDAR system of claim 1 wherein the array comprises first and second light detectors each of which receive reflected emitted light, and the system further includes a signal processor connected to the first and second light detectors that derives phase differences between signals received by the first light detector and signals received by the second light detector.

7. The LIDAR system of claim 1 wherein the the array of light detectors is located on the same focal plane of an optical system such as a lens.

8. A method of operating a LIDAR system comprising:
emitting modulated light,
generating a signal reference,
using an array of light detectors to receive emitted light reflected from an object(s), and
demodulating the received emitted light for comparison to the signal reference to derive phase differences related to distance of the object(s).

9. The method of claim 6 further including co-locating the light emitter and array of light detectors.

10. The method of claim 6 further including not transporting any message from the light emitter to the array of light detectors over the modulated light.

11. The method of claim 6 further including determining ranges from the phase differences to provide a 3D point cloud.

12. The method of claim 6 further including filtering out phase effects due to ambient light.

13. The method of claim 6 wherein the array comprises first and second light detectors each of which receive reflected emitted light, and the method further includes deriving phase differences between signals received by the first light detector and signals received by the second light detector.

14. The method of claim 6 further including locating the array of light detectors on the same focal plane of an optical system such as a lens.
